(19) United States
(12) Patent Application Publication
(10) Pub. No.: US 2020/0261296 A1
(43) Pub. Date: Aug. 20, 2020

(54) Therapeutic Leg Support Device

(71) Applicant: Bryan Kilbey, DeFuniak Springs, FL (US)

(72) Inventor: Bryan Kilbey, DeFuniak Springs, FL (US)

(21) Appl. No.: 16/280,562

(22) Filed: Feb. 20, 2019

(51) Int. Cl. A61G 13/12

(52) U.S. Cl. CPC A61G 13/1245; A61G 13/125

(57) ABSTRACT

A therapeutic device for supporting one or both of a patient's legs. The device is preferably constructed using a semi-rigid, and moderately flexible foam material such as polyurethane foam. The therapeutic leg support device includes a top portion, a base, a foot cutout located on the top portion, and a bottom cutout located on the base. Once a patient's foot and leg are placed into the foot cutout, the leg support device hinges in order to clasp the patient's leg. This prevents the patient's leg from twisting and/or falling out of the support device. Preferably, the therapeutic leg support device includes a connection mechanism on each side of the device. The user can interlock multiple leg support devices via the connection mechanism. This allows the patient to place both legs and feet into the foot cutouts, allowing for full hip abduction as well as facilitating full extension.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

This invention relates to the field of medical devices. More specifically, the invention comprises a device which is used to support at least one of a patient's legs in order to assist in a physician's pre- and post-operative protocol.

### 2. Description of the Related Art

The recovery period for a patient following surgery or other medical interventions is important.

The recovery period often includes intervals of rest, physical therapy, and some variation of elevation, fixation, or flexion of appendages affected in the treatment. Of course, the method of recovery depends on the type and severity of the injury/surgery. In the case of arms and legs, the patient is often required to fix the appendage in an elevated position. The elevation is most often accomplished using a pillow or sling.

A knee replacement procedure replaces the weight bearing surfaces of the knee to relieve pain and to restore mobility. A knee replacement procedure may be total or partial. After the procedure is complete, vigorous post-operative rehabilitation is typically required. This includes physical therapy. One very important exercise that a patient must do after having a knee replacement procedure is a passive hamstring stretch. The passive hamstring stretch is typically achieved by placing the foot of the patient on a pillow or other object in order to raise the leg off the supporting surface. The leg is then suspended from the hip joint and the ankle joint, and the w eight of the leg extends the knee joint and stretches the hamstring. This exercise is crucial for restoring the patient's gait. Unfortunately, the patient's foot may slip off of the pillow or other object causing a great deal of pain. This risk discourages the patient and limits the physician's pre- and post-operative rehabilitation protocol.

Similarly, a hip replacement procedure is performed in order to alleviate pain and/or if the hip socket has been fractured. As with the knee replacement procedure, rest and physical therapy are required after the procedure is complete. After a hip surgery, it is preferred to keep the hips in abduction. This is often achieved using a pillow placed in between the legs of the user, which separates the knees and increases the angle of abduction.

While many devices provide an elevation means or separating means for a patient's legs, the prior art devices do not provide a single device which achieves both hip abduction and knee extension while locking the patient's ankle in place. The present invention solves these and other problems, as will be described more particularly in the following text.

### BRIEF SUMMARY OF THE INVENTION

The present invention comprises a therapeutic device for supporting one or both of a patient's legs. The device is preferably constructed using a semi-rigid, and moderately flexible foam material such as polyurethane foam. The therapeutic leg support device includes a top portion, a base, a foot cutout located on the top portion, and a bottom cutout located on the base. The foot cutout is preferably designed to fit the foot and leg of a patient. Once a patient's foot and leg are placed into the foot cutout, the leg support device bends inward in a hinge-like manner in order to clasp the patient's leg. This action prevents the patient's leg from twisting and/or falling out of the support device.

In a preferred embodiment of the present invention, the therapeutic leg support device includes a connection mechanism on each side of the device. The user can interlock multiple leg support devices via the connection mechanism. This allows the patient to place both legs and feet into the foot cutouts, allowing for full hip abduction while securing the position of both legs with respect to each other.

### BRIEF DESCRIPTION OF THE SEVERAL VIEWS OF THE DRAWINGS

FIG. 1 is a perspective view, showing a preferred embodiment of the present invention.

FIG. 2 is an elevation view, showing the embodiment of FIG. 1.

FIG. 3 is a perspective view, showing the present invention receiving the foot and leg of a patient.

FIG. 4 is a schematic view, showing the effect of applying a force to the inner surface of the foot cutout of the present invention.

FIG. 5 is a perspective view, showing the effect of placing a patient's leg and foot into the foot cutout of the present invention.

FIG. 6 is a perspective view, showing one type of connection mechanism that may be used in the present invention.

FIG. 7 is a perspective view, showing two therapeutic leg support devices attached using the connection mechanism depicted in FIG. 6.

FIG. 8 is a perspective view, showing two therapeutic leg support devices prior to attaching the support devices.

### REFERENCE NUMERALS IN THE DRAWINGS

10 therapeutic leg support device
12 top portion
13 first side surface
4
14 base
15 second side surface
16 foot cutout
17 first column
18 bottom cutout
19 second column
20 surface
21 web
22 patient's leg
24 patient's foot
26 pivot point
28 connection mechanism
30 protrusion
32 channel
34 hook and loop fastener

### DETAILED DESCRIPTION OF THE INVENTION

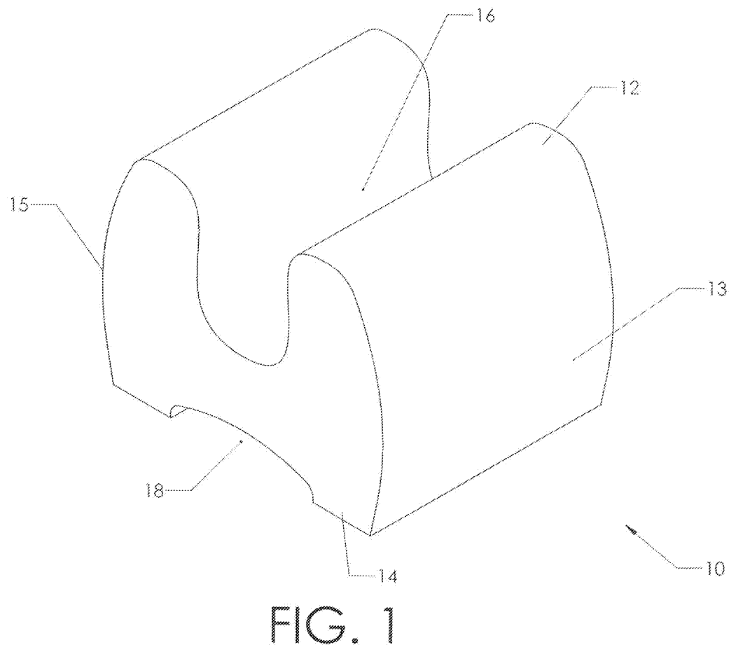

The present invention comprises a therapeutic leg support device 10. A preferred embodiment of therapeutic leg support device 10 is shown in FIG. 1. Therapeutic leg support device 10 includes a top portion 12, a base 14, a first side 13, and a second side 15. Base 14 of leg support device 10 is designed to rest on a surface such as a floor or a bed. Top portion 12 of support device 10 opens into foot cutout 16. Foot cutout 16 is preferably designed to fit the lower leg, ankle, and foot of a patient. Those familiar with the art will know that a general elliptical or parabolic shape is sufficient to surround the foot of a patient. Of course, the profile of toot cutout 16 may take many shapes if so desired or required—including straight wall portions. In addition, base 14 includes bottom cutout 18. As illustrated, bottom cutout 18 is preferably in the shape of an arch.

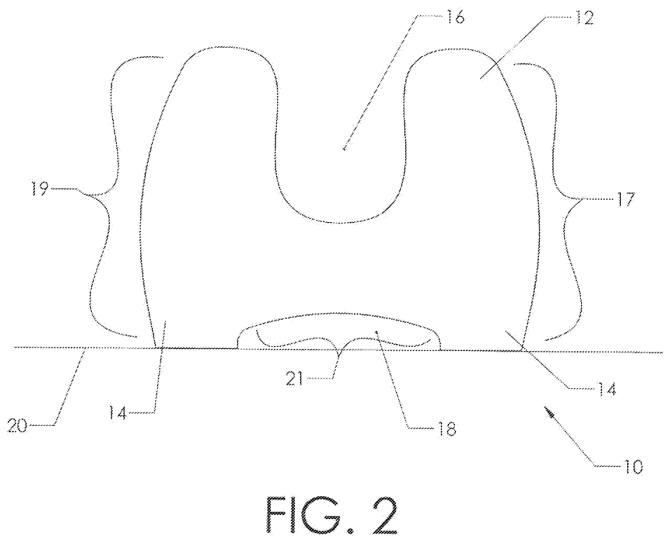

FIG. 2 shows a front elevation view of therapeutic leg support device 10. In this view, the profile of foot cutout 16 is clearer. Also, the reader can see that bottom cutout 18 in this embodiment defines the shape of an arch. The reader will note that in FIG. 2 leg support device 10 is in an unloaded state. In other words, a patient's foot or leg is not resting within support device 10 and it is free-standing and in an unloaded (un-deformed) state. While in an unloaded state, base 14 rests flat upon surface 20. Surface 20 van be a bed, table, a door, a vouch, or any other desirable surface. In addition to base 14 resting flat upon surface 20, the figure shows no deformation of top portion 12 or bottom cutout 18. The material used in the invention is stiff enough to remain un-deformed when unloaded.

The shape thus created has three major elements. A first column 17 extends from base 14 to top portion 12 on one side. A second column 19 extends from base 14 to top portion 12 on the other side. The two columns are joined by web 21 proximate base 14.

Before and/or after a full or partial knee replacement or other knee surgery is performed on a patient, it is important for the patient to fully extend his or her knee. One method of doing this is to elevate the patient's ankle/foot while he or she is lying down. Typically, this is achieved with a standard pillow. Unfortunately, a typical pillow does not offer any lateral support for the patient's foot/leg. The foot is able to translate laterally and also roll from side to side. The present invention solves these problems.

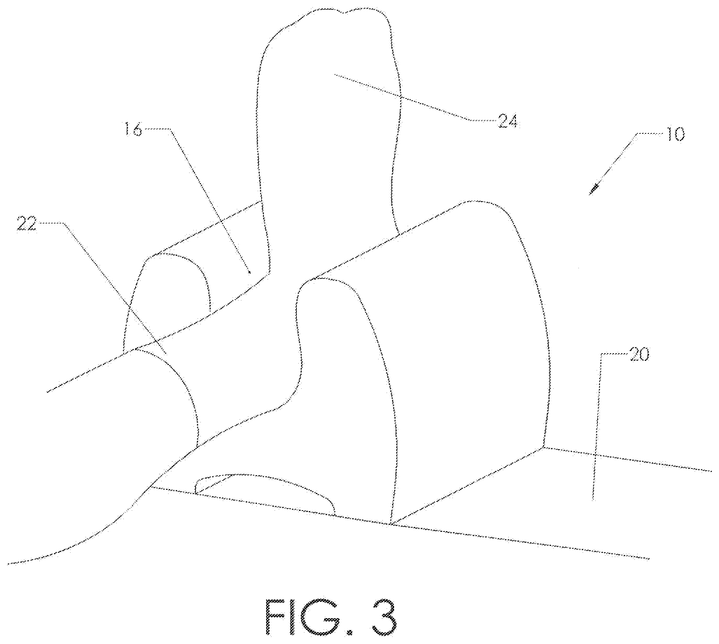

FIG. 3 shows a patient's leg 22 and foot 24 (having a sock covering patient's leg and foot) as it is being inserted into therapeutic leg support device 10. Leg support device 10 is resting on surface 20. As shown, the patient's leg 22 and foot 24 are placed within foot cutout 16. The reader will note that support device 10 is still in an unloaded state because the patient has not fully released the weight of his or her leg 22 onto support device 10.

In a preferred embodiment of the present invention, therapeutic leg support device 10 is fabricated using a molded foam such as polyurethane. The density and stillness of the foam is selected so that it is flexible enough to deform to a desired extent when a patient places his or her leg 22 into foot cutout 16. Those familiar with the art will realize that if leg support device 10 compresses too easily, then the patient's leg 22 and foot 24 will descend to the point that the desired elevation is no longer achieved. It is desirable for the support device to compress just enough to grip and stabilize the foot, ankle, and lower leg in the desired elevated position. A suitable polyurethane loam provides the desired characteristics. Such a foam will return to its original shape once the patient's leg is removed. The reader will note that leg support device 10 may be formed using a single piece of molded foam or multiple pieces of foam fastened together which act as a single piece of loam.

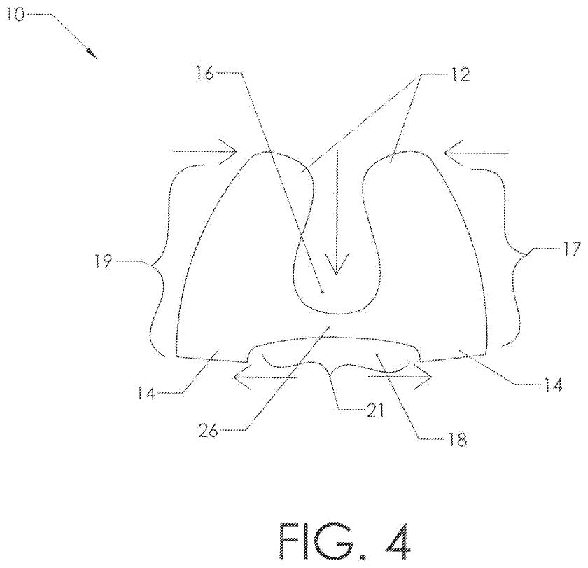

FIG. 4 shows the effect of placing a patient's foot and leg into toot cutout 16 and allowing the weight of the foot and leg to load the device (the “loaded state”). The reader will note that FIG. 4 shows the loaded state but the foot and leg are not shown for purposes of visual clarity. The downward arrow represents the force created by the weight of patient's leg 22 and foot 24. Those familiar with the art will realize that as a downward force is applied to foot cutout 16, the arch defining bottom cutout 18 will deflect downward. The two contact surfaces of base 14 will also splay outward as shown by the two outward-facing arrows. The flexibility of support device 10 results in the upper portion of first column 17 and second column 19 leaning inward while the base portions of the column lend to move outward. The location and configuration of cutout 18 allows the two columns to pivot about an approximate imaginary pivot point 26, as shown. Web 21 also bends as shown.

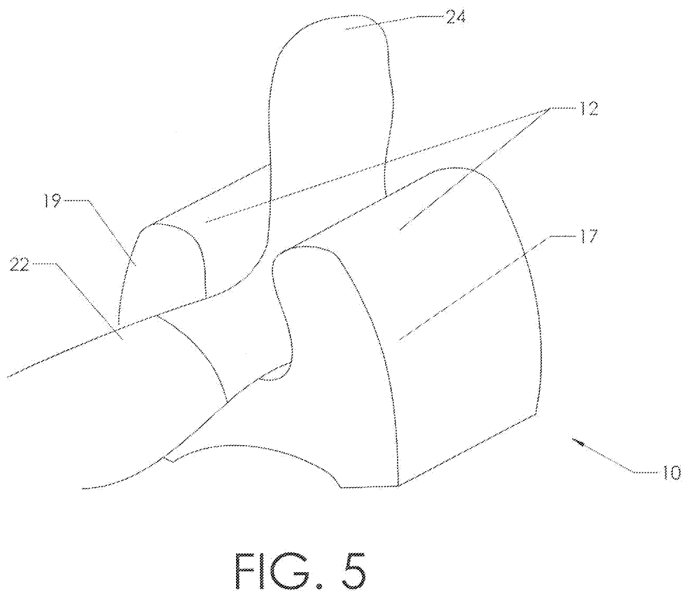

As top portions 12 of the two columns move inward they clamp and stabilize the patient's foot, ankle, and lower leg. The readily-deformable nature of the foam allows the device to mold around an individual's anatomy without producing excessive pressure on any one point. FIG. 5 shows the result. First column 17 and second column 19 surround and enclose patient's leg 22 and loot 24 (covered by a sock), thereby preventing the user's leg 22 from twisting or falling out of leg support device 10. In addition, although the web of the support device has deflected downward somewhat, it still retains the desired elevated position and thereby keeps the patient's foot elevated. Thus, the knee is allowed to achieve full extension, which is preferable for pre- and post-operative rehabilitation protocols.

Those familiar with the art will recognize the importance of preventing the patient's leg and foot from twisting and/or falling out of support device 10. While extension and flexion of the patient's knee after surgery is important, twisting and sudden movements can be detrimental to the knee and the healing process of the knee. Thus, it is important to prevent the knee of the patient from twisting or failing This support is not provided when using a typical prior art pillow or other support structures but is provided with the present invention.

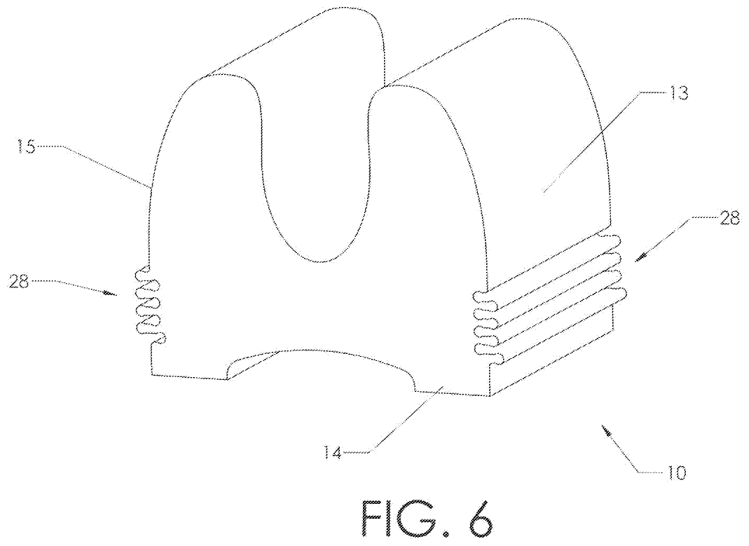

Another embodiment of the present invention is shown in FIG. 6. In some instances it is desirable to use two leg support devices 10 in conjunction. This is particularly true after hip surgery, when two inventive supports may be used to maintain a desired geometric relationship between the patient's two legs. In order to facilitate this functionality, it is desirable to include connection features allowing two or more of the leg support devices to be connected.

In FIG. 6, leg support device 10 includes connection mechanism 28. As illustrated, there is a connection mechanism 28 located on each side of therapeutic leg support device 10. The connection mechanism 28 located on first side surface 13 mates with the connection mechanism 28 on second side surface 15. In the embodiment shown, connection mechanism 28 comprises a plurality of protrusions 30 and channels 32. The protrusions 30 and channels 32 form an interlocking array. The array on second side surface 15 is the opposite of the army on first side surface 13. In other words, a protrusion on one side corresponds to a channel on the other.

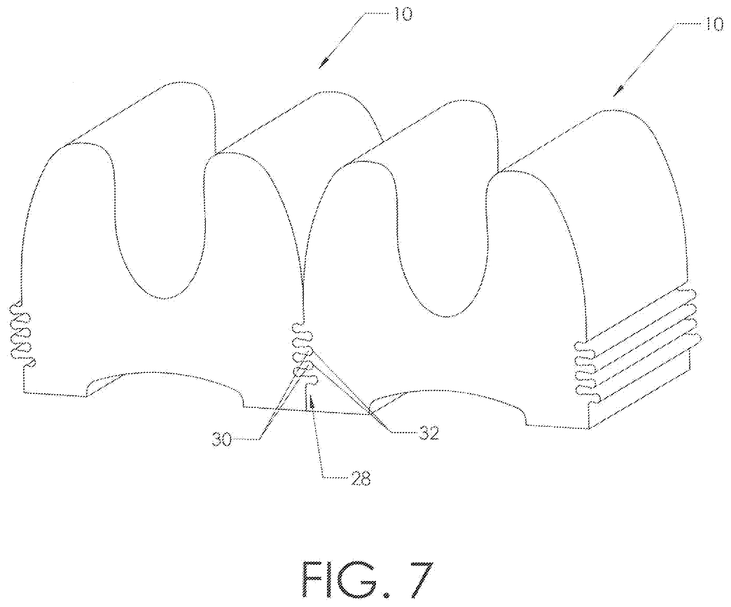

FIG. 7 shows two therapeutic leg support devices 10 connected via connection mechanism 28. As shown, protrusions 30 on a first side of a first leg support device 10 fit into channels 32 on a second side of a second leg support device 10. Those familiar with the art will know that the foam material from which leg support device 10 is fabricated allows a user to easily force protrusions 30 into channels 32. Once two therapeutic leg support devices 10 are joined, a patient can place one leg in each device 10. This facilitates hip abduction, which is part of the pre- and post-operative rehabilitation protocol. In addition, if the patient's ankles are place upon leg support device 10, then heel sores (a very common problem after hip surgery) can be reduced or eliminated. Elevation in general allows for extension, which is important for normal gait action and reduction in edema.

The inventive device is usually employed to secure the patient's foot, ankle, or lower leg in position. However, in different instances it may only be used to secure one portion (such as the ankle). Accordingly, the patient's anatomy will be generally referred to as “lower limb anatomy” and this will be understood to encompass some or all of the region including the foot, ankle, and lower leg. Likewise, the term “foot cutout” has been used to describe the opening in the top of the inventive device. The use of this term should not be viewed as limiting the application of the device. In some instances, for example, only the patient's ankle will be placed in the “foot cutout.”

Moreover, the position of the lower limb anatomy on support device 10 impacts the force applied to the knee. For example, the maximum amount of force is applied to the knee when the tip of the heel of a patient is resting on the leg support device 10. This force is directly related to extension since the leg is suspended from the hip joint, and the weight of the patient's leg extends the knee and stanches the hamstring. In some instances, this force may be too great for the patient. By placing more and more of the lower limb anatomy onto leg support device 10, the force upon the knee is reduced. Thus, the force generated on the knee when the calf of the user is resting upon leg support device 10 is less than the force generated when the ankle of the user is resting upon leg support device 10.

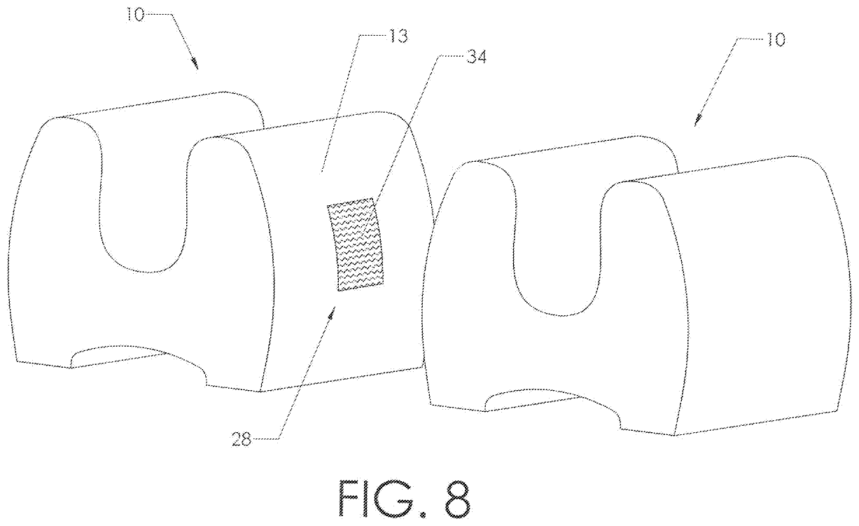

FIG. 8 shows two therapeutic leg support devices 10. In this embodiment of the present invention, connection mechanism 28 is a hook and loop fastener 34. In some embodiments, hook and loop fastener 34 is attached to first side surface 13 using an adhesive. Preferably, hook and loop fastener 34 is capable of adhering to itself. Oftentimes hook and loop fasteners have separate sections for the hook and loop portions. However, the present invention prefers the hook and loop structures to be present on each hook and loop fastener 34. This allows the user to use a single hook and loop fastener 34 on each leg support device 10 without having distinct corresponding fasteners.

The preceding description contains significant detail regarding novel aspects of the present invention. As an example, connection mechanism 28 could be any mechanism used to fasten two support devices 10 together such as a temporary or permanent adhesive. It should not be construed, however, as limiting lire scope of the invention but rather as providing illustrations of the preferred embodiments of the invention. Thus, the scope of the invention should be fixed by the following claims, rather than by examples given.

Having described our invention, we claim:

1. A therapeutic leg support device for supporting a patient's lower limb anatomy, comprising:
a. a first column having a top portion and a base;
b. a second column having a top portion and a base;
c. a web connecting said first and second columns, said web being connected to each of said columns proximate said base of said columns;
d. said first column, said second column, and said web being made from a single piece of flexible foam;
e. said first column, said second column, and said web combining to define a foot cutout extending from said top port ions of said columns down to said web;
f. said first column, said second column, and said web combining to define a bottom cutout extending from said base of said columns up to said web;
g. wherein said bottom cutout includes an arch; and
h. said columns and said web configured such that when said patient's lower limb anatomy is placed in said foot cutout and a weight of said lower limb anatomy is placed on said web said web deflects downward and said top portions of said columns tilt inward so that said columns clamp said patient's lower limb anatomy in place while maintaining said lower limb anatomy in an elevated position.

2. A therapeutic leg support device as recited in claim 1, further comprising:
a. said therapeutic leg support device having a first side and a second side;
b. a first connection mechanism located on said first side of said leg support device;
c. a second connection mechanism located on second side of said leg support device; and
d. wherein said first connection mechanism and said second mechanism fix multiple leg support devices together.

3. A therapeutic leg support device as recited in claim 2, wherein said first connection mechanism comprises a series of alternating channels and protrusions and said second connection mechanism comprises a series of alternating channels and protrusions which correspond to said channels and protrusions of said first connection mechanism such that said channels and said protrusions interlock.

4. A therapeutic leg support device as recited in claim 2, wherein said first connection mechanism and said second connection mechanism create a temporary connection between two leg support devices.

5. A therapeutic leg support device as recited in claim 2, wherein said first connection mechanism and said second connection mechanism contain both hook and loops in order to create a hook and loop fastener.

6. A therapeutic leg support device as recited in claim 1, wherein said leg support device is fabricated using molded foam such as polyurethane foam.

7. A therapeutic leg support device for supporting a patient's lower limb anatomy, comprising:
a. a first column having a top portion and a base;
b. a second column having a top portion and a base;
c. a web connecting said first and second columns, said web being connected to each of said columns proximate said base of said columns;
d. said first column, said second column, and said web being made from a single piece of flexible material;
e. said first column, said second column, and said web combining to define a foot cutout extending from said top portions of said columns down to said web;
f. said first column, said second column, and said web combining to define a bottom cutout extending from stud base of said columns up to said web; and
g. said columns and said web configured such that when said patient's lower limb anatomy is placed in said foot cutout and a weight of said lower limb anatomy is placed on said web said web deflects downward and said top portions of said columns tilt inward so that said columns clamp said patient's lower limb anatomy in place while maintaining said lower limb anatomy in an elevated position.

8. A therapeutic leg support device as recited in claim 7, further comprising:
a. said therapeutic leg support device having a first side and a second side;
b. a first connection mechanism located on said first side of said leg support device; and
c. a second connection mechanism located on second side of said leg support device.

9. A therapeutic leg support device as recited in claim 8, wherein:
a. said first connection mechanism includes a series of protrusions and channels;
b. said second connection mechanism includes a series of protrusions and channels; and
c. said protrusions from said first connection mechanism are capable of being inserted into said channels from second connection mechanism and said channels from said first connection mechanism are capable of receiving said protrusions from said second connection mechanism in order to form an interlocking connection between two of said leg support devices.

10. A therapeutic leg support device as recited in claim 9, wherein said first connection mechanism and said second connection mechanism create a temporary connection between two leg support devices.

11. A therapeutic leg support device as recited in claim 8, wherein said first connection mechanism and said second connection mechanism contain both hook and loops in order to create a hook and loop fastener.

12. A therapeutic leg support device as recited in claim 7, wherein said bottom cutout includes an arch.

13. A therapeutic leg support device as recited in claim 7, wherein said leg support device is fabricated using molded foam such as polyurethane foam.

14. A therapeutic kg support device for supporting a patients lower limb anatomy, comprising:
a. a first, column having a top portion and a base;
b. a second column having a top portion and a base;
c. a web connecting said first and second columns, said web being connected to each of said columns proximate said base of said columns;
d. said first column, said second column, and said web being made of flexible material;
e. said first column, said second column, and said web combining to define a foot cutout extending from said top portions of said columns down to said web;
f. said first column, said second column, and said web combining to define a bottom cutout extending from said base of said columns up to said web;
g. wherein said bottom cutout includes an arch; and
h. said columns and said web configured such that when said patient's lower limb anatomy is placed in said foot cutout and a weight of said lower limb anatomy is placed on said web said web deflects downward and said top portions of said columns lilt inward so that said columns clamp said patient's lower limb anatomy in place while maintaining said lower limb anatomy in an elevated position.
